(19) United States
(12) Patent Application Publication
(10) Pub. No.: US 2012/0115112 A1
(43) Pub. Date: May 10, 2012

(54) LANGUAGE TRAINING SYSTEM

(76) Inventors: Ravi Purushotma, Redwood City, CA (US); Daniel Roy, Cambridge, MA (US)

(21) Appl. No.: 13/293,548

(22) Filed: Nov. 10, 2011

Related U.S. Application Data
(60) Provisional application No. 61/412,297, filed on Nov. 10, 2010.

(51) Int. Cl. G09B 19/06

(52) U.S. Cl. 434/157

(57) ABSTRACT

One example embodiment includes a system for teaching a user a target language. The system includes a media repository, where the media repository is configured to store media in the target language. The system also includes a text repository, where the text repository is configured to store one or more lines of text from the media stored in the media repository.

### CROSS-REFERENCE TO RELATED APPLICATIONS

This application claims the benefit of and priority to U.S. Provisional Patent Application Ser. No. 61/412,927 filed on Nov. 10, 2010, which application is incorporated herein by reference in its entirety.

### BACKGROUND OF THE INVENTION

For most people in the world, being able to speak an additional language would be of notable benefit to their lives and everyday circumstances. Thus, a variety of learning mechanisms have been devised for acquiring them: classrooms are organized around language instruction, self-study books and tapes are available at most libraries, personal tutors can be hired to facilitate conversations, etc. Each of these mechanisms, however, generally involves a departure from the learner's everyday recreational activities to instead engage them in the learning process. For example, instead of watching their favorite television program, a learner might initially choose spend an hour studying a textbook.

Once learners have achieved a relatively advanced proficiency in a language, they can then further their learning by consuming media in the target language. For example, a French learner could watch movies, listen to songs or read newspapers in French to improve their knowledge. This process is advantageous because, besides immersing the learner in authentic and often grammatically rich exemplars of the target language, it allows them to engage in an enjoyable activity they might take part in even if they were not attempting to learn a target language. Given these advantages, beginner learners may often try to find ways of emulating this process—such as keeping a cross-language dictionary by their side while attempting to read a target language newspaper. However, these assisting processes are often inconvenient and slow down the rate at which learners can engage with target language media to undesirable levels. Thus, a need persists for ways in which beginner and intermediate learners can effectively consume target language media in ways that are fun and allow them to acquire the language used at a faster pace.

An alternative approach to making language learning fun is to design video games learners can play in order to practice using a language. However, making games that are simultaneously fun and teach a language is a difficult challenge. Thus, language-learning games of the current art often have extremely limited content, are only able to teach small and specific aspects of a target language, have high development costs and often are not as fun as entertainment-focused video games. As such, a need persists for a mechanism by which video games capable of teaching numerous aspects of a target language can be constructed, in a cost effective manner, which can be played in the way entertainment-focused games are played for fun.

Therefore, it is the object of the current invention to provide a mechanism by which content from foreign media in a target language to be learned can be extracted in such a way that it can be used to construct video games consistent with the designs also found in entertainment-focused games, and presented with enough in-game learning support systems that a beginner or intermediate learner can successfully use the invention to acquire multiple aspects (pronunciation, conjugation/inflection, word order, etc.) of a target language, and can be offered in a convenient and practical manner that can be integrated in with the learner's everyday life.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for teaching a user a target language. The system includes a media repository, where the media repository is configured to store media in the target language. The system also includes a text repository, where the text repository is configured to store one or more lines of text from the media stored in the media repository. The system further includes a user interface, where the user interface is configured to display a line of text stored in the text repository.

Another example embodiment includes a system for teaching a user a target language. The system includes a display. The system also includes media in a target language, where at least a portion of the media is presented on the display. The system further includes target language challenges, where the target language challenges test a user on portions of the media.

Another example embodiment includes a method for teaching a user a target language. The method includes preparing media for language instruction. The method also includes storing the prepared media. The method further includes executing an instruction mode.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a block diagram of a system for teaching target language;

FIG. 2 is a flowchart illustrating a method of teaching a user a target language using a scrambled mode;

FIG. 3 illustrates an example of a GUI for teaching a user a target language using a scrambled mode;

FIG. 4 is a flow chart illustrating a method of teaching a user a target language using a quick match mode;

FIG. 5 illustrates an example of a GUI for teaching a user a target language using a quick match mode;

FIG. 6 is a flow chart illustrating a method of teaching a user a target language using a guess the next line mode;

FIG. 7 illustrates an example of a GUI for teaching a user a target language using a guess the next line mode;

FIG. 8 is a flowchart illustrating a method of teaching a user a target language using a scene match mode;

FIG. 9 illustrates an example of a GUI for teaching a user a target language using a scene match mode;

FIG. 10 is a flowchart illustrating a method of teaching a user a target language using a finger karaoke mode;

FIG. 11 illustrates an example of a GUI for teaching a user a target language using a finger karaoke mode;

FIG. 12 is a flow chart illustrating a method of teaching a user a target language using an impostor mode;

FIG. 13 illustrates an example of a GUI for teaching a user a target language using an impostor mode;

FIG. 14 is a flow chart illustrating a method of teaching a user a target language using an interlude mode;

FIG. 15 illustrates an example of a GUI for teaching a user a target language using an interlude mode;

FIG. 16 is a flowchart illustrating a method of teaching a user a target language using a picture it mode;

FIG. 17 illustrates an example of a GUI for teaching a user a target language using a picture it mode; and

FIG. 18 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

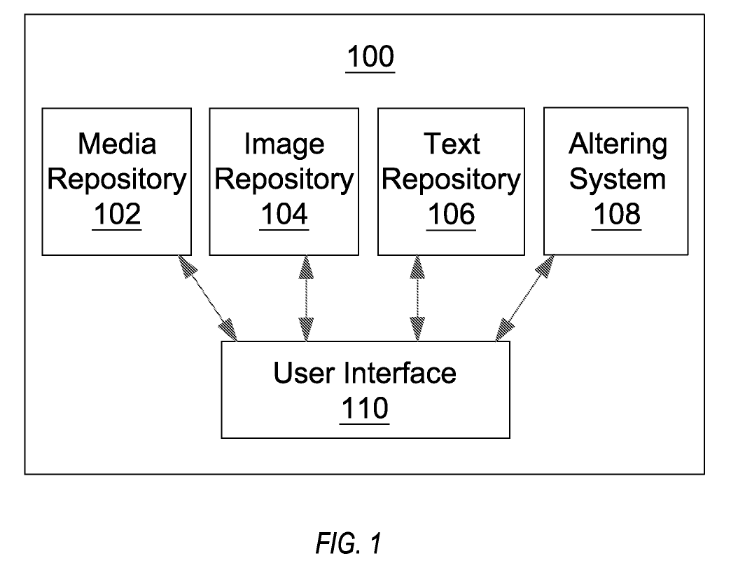

FIG. 1 illustrates a block diagram of a system 100 for teaching a target language. For example, the target language can include a foreign language. In at least one implementation, the system 100 can entertain a user while the user learns the target language. In particular, the system 100 can allow the user to learn the target language using media in the target language.

FIG. 1 shows that the system 100 can include a media repository 102. In at least one implementation, the media repository 102 can store information from media in a target language or any alternate translations of the media. For example, the media repository 102 can include movies, tv shows, music, games, books, magazines, newspapers, web pages or any other desired media from the target language. The media repository 102 can allow the user to view or listen to the media while learning the target language.

FIG. 1 also shows that the system 100 can include an image repository 104. In at least one implementation, the image repository 104 can store images related to the media. For example, the image repository 104 can include screen shots, cover art, maps, diagrams or other images from the media. Additionally or alternatively, the image repository 104 can include one or more data tags that indicate where the desired image occurs in the media. For example, the data tag can include a pointer to a particular timeframe within a song or video.

FIG. 1 further shows that the system 100 can include a text repository 106. In at least one implementation, the text repository 106 can include text from the media. For example, the text repository can include subtitles, lyrics, content or any other desired text. The text can be stored in both the original language of the media and any desired alternative languages. I.e., the text repository 106 can include text in both the target language and in the native language of the user. Additionally or alternatively, the text can be associated with a time code. In at least one implementation, the time code can identify the position of the text within the media or within an audio clip from the media. Additionally or alternatively, the time code can be used to identify an audio clip from one or more audio clips from the media. I.e., the time code can include information about which audio clip is associated with the text.

FIG. 1 additionally shows that the system 100 can include an altering system 108. In at least one implementation, the altering system 108 can alter portions of the text in the text repository 106 or portions of the images stored in the image repository. For example, altering the text can include changing portions of the text, obscuring the text, highlighting the text, changing the font of the text, changing the appearance of the text, animating the text, translating the text to another language, replacing the text, removing portions of the text or any other desired change. In particular, the altering system 108 can allow the user to be tested on different language skills, as described below.

FIG. 1 additionally shows that the system 100 can include a user interface 110. In at least one implementation, the user interface 110 can allow the user to view, hear or otherwise interact with the media. For example, the user interface 110 can include a graphical user interface, controls, speakers, displays or any other necessary hardware and/or software to adequately display the media to the user, as described below.

In at least one implementation, a graphical user interface (“GUI” sometimes pronounced gooey) is a type of user interface 110 that allows users to interact with electronic devices with images rather than text commands. GUIs can be used in computers, hand-held devices such as MP3 players, portable media players or gaming devices, cell phones, household appliances and office equipment. A GUI represents the information and actions available to a user through graphical icons and visual indicators such as secondary notation, as opposed to text-based interfaces, typed command labels or text navigation. The actions are usually performed through direct manipulation of the graphical elements.

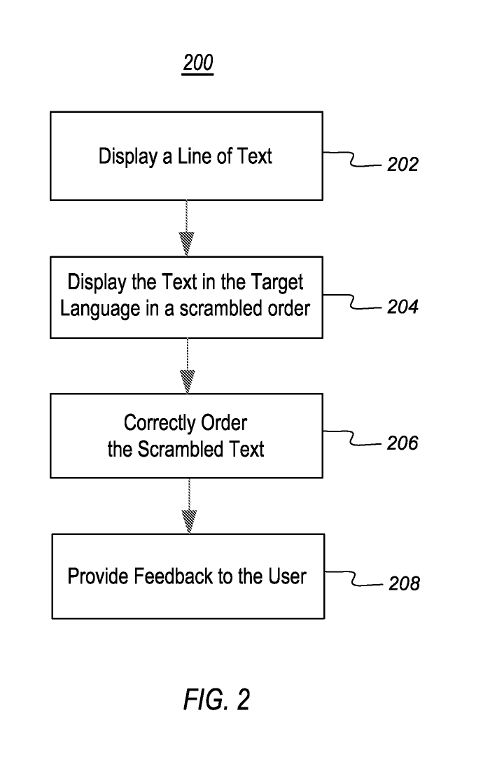

FIG. 2 is a flowchart illustrating a method 200 of teaching a user a target language using a scrambled mode. In at least one implementation, the method 200 can be implemented using the system 100 of FIG. 1. Therefore, the method 200 will be described, exemplarily, with reference to the system 100 of FIG. 1. Nevertheless, one of skill in the art can appreciate that the method 200 can be implemented using systems other than the system 100 of FIG. 1. In at least one implementation, the displaying 202 a line of text includes any presentation of the text for visual, tactile or auditive reception. For example, the line of text can be displayed 202 as text on a screen. Additionally or alternatively, the line of text can be presented 202 as spoken words on speakers for the user to hear. The line of text can be displayed 202 from the text repository 106 after being extracted from the desired media in the media repository 104.

FIG. 2 shows that the method 200 can include displaying 202 a line of text. In at least one implementation, the line of text can be displayed 202 in the user's native language. For example, the line of text can be displayed 202 from the text repository 106 after being extracted from the desired media in the media repository 104. One of skill in the art will appreciate that a “line” of text need not be a single sentence and need not be shown as text. I.e., as used herein, the term line of text can include all or some of chapters, sections, paragraphs, sentences, phrases, words, affixes, lines, class of words, phrase types or any other desired division. Class of words can include the word type, such as noun, verb, object, subject, article, preposition, etc.

FIG. 2 also shows that the method 200 can include displaying 204 the text in the target language in scrambled order. For example, the subtitles or other text from the media translated for popular consumption can be produced and scrambled. In particular, the text can be scrambled by the altering system 108. Additionally or alternatively, phrases or other text segments can be reordered. Additionally or alternatively, additional incorrect “distractor” words may be inserted into the pool of words that a user selects from. These could be generated is similar but incorrect variants of the correct words in the same technique used in the impostor mode, described below.

FIG. 2 further shows that the method 200 can include correctly ordering 206 the scrambled text. In at least one implementation, correctly ordering 206 the scrambled text can allow the user to practice the proper construction of a sentence in the target language. I.e., the user can practice proper word order in the target language by reordering the sentence into a construction that would be used by a native speaker.

In at least one implementation, more than one user can correctly order 206 the scrambled text in the target language. I.e., two or more users can each simultaneously attempt to correctly order 206 the scrambled text. The two or more users can assist each other or be in competition with one another. For example, the two or more users can work with one another to determine the correct order. Additionally or alternatively, the two or more users can compete with one another. For example, if one user correctly places a portion of the text, then both users can see the correctly placed text, removing it as an option from both players' selection pools, and compete to correctly place the most portions. Alternatively, the users can compete to see who can complete the correct order the quickest or compete in any other desired manner.

FIG. 2 additionally shows that the method 200 can include providing 208 feedback to the user. In at least one implementation, the feedback can include textual or image supports that help the user understand where he/she made mistakes. Additionally or alternatively, the feedback can include information about the speed and/or accuracy of the user's answer. If players are competing, penalties may be implemented for incorrect answers. For example, if one user places a portion of the text in an incorrect position, their turn may be skipped, their input may be “frozen” for a specified period of time, they can have points deducted from a score or any other appropriate penalty can be implemented.

As an additional feedback mechanism, the system includes a set of musical stings. The musical stings are segmented to correspond to the number of pieces to be unscrambled. For example, if the round includes 8 text segments to be unscrambled, one implementation may include a musical sting containing 8 notes. As the players select correct answers, the next note in the sting is played. If the player selects and incorrect answer, a sound not part of the musical sting is played, giving the players a jarring sense and letting them feel that their answer was incorrect. As a reward for correctly unscrambling the round, the audio clip of the media item can be played either upon completion or as the player is descrambling the pieces of the set. Additionally or alternatively, the audio clip may be played before the user begins descrambling the set in order to make the mode more accessible to beginner players.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

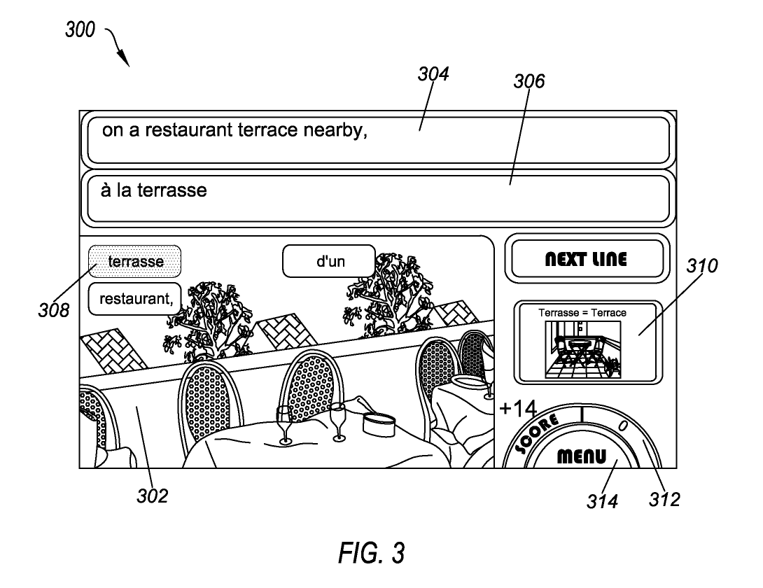

FIG. 3 illustrates an example of a GUI 300 for teaching a user a target language using a scrambled mode. In at least one implementation, the GUI 300 can allow the user to interact with the target language. I.e., the user can be immersed in the target language. In particular, the user can be focused on the target language in such a way that the user is interacting with the target language rather than on rote memorization of the target language.

FIG. 3 shows that the GUI 300 can include an image 302. In at least one implementation, the image 302 can be a picture or video clip taken from the image repository. I.e., the image 302 can include an image from the media stored in the media repository 102. The user may be able to select from different media in the media repository 102, thus the user may select media with which he/she is already familiar. This can reinforce the language learning because the user is “working” in a familiar environment.

FIG. 3 also shows that the GUI 300 can include a first text box 304. In at least one implementation, the first text box 304 can display to a user a line of text. In particular, the line of text can be in the user's native tongue or other language that the user is familiar with and associated with the image 302. I.e., the image 302 and the line of text in the first text box 304 can occur simultaneously in the media, the image 302 can show the action described in the line of text, or the image 302 and the line of text can be associated in some other way.

FIG. 3 further shows that the GUI 300 can include a second text box 306. In at least one implementation, the second text box 306 can begin the round empty. I.e., the second text box 306 can contain no text when first displayed to the user. Instead, the user can be asked to insert the text in the second text box 306 which is the correct or alternate translation of the text in the first text box 304. Additionally or alternatively, the second text box 306 may begin with some of the text inserted as a hint or help to the user.

FIG. 3 additionally shows that the GUI 300 can include pieces of text 308. In at least one implementation, the user can be given some or all of the text that should be assembled in the second text box 306. For example, if the user is a beginner in the target language, the second text box 306 might start partially filled in and he/she may be given the remaining segments as pieces of text 308 to select. Otherwise, a moderately advanced player would begin with a blank second text box 306 and be required to reconstruct the entire line of text in the second text box 306, using the pieces of text 308.

FIG. 3 also shows that the GUI 300 can include one or more hints 310 for the user. In at least one implementation, the one or more hints 310 can allow the user to see a translation of a word, phrase or other text segment in the target language into a word, phrase or other text segment in his/her native language or show an image which can help the user understand the meaning of the word, phrase or other text segment. Additionally or alternatively, the one or more hints 310 can insert one or more pieces of text 308 in their correct position within the second text box 306.

FIG. 3 further shows that the GUI 300 can include feedback 312. In at least one implementation, the feedback 312 can allow a user to determine how he/she is doing thus far in the exercise. I.e., the feedback 312 can allow the user to gauge his/her progress thus far. Additionally or alternatively, the feedback 312 can be used to determine the difficulty of the exercise for the user. For example, if the user is getting high scores or the exercise otherwise seems too easy for the user, the feedback 312 can be used to automatically increase the difficulty for the user.

FIG. 3 additionally shows that the GUI 300 can include one or more controls 314. In at least one implementation, the one or more controls 314 can allow the user to control the exercise. For example, the user can be asked to assemble the pieces of text 308 in the second text box 306. By selecting any text segment, they can receive textual and visual feedback 310. Additionally or alternatively, the one or more controls can allow the user to ask for a hint 310, move to the next exercise or perform any other desired function.

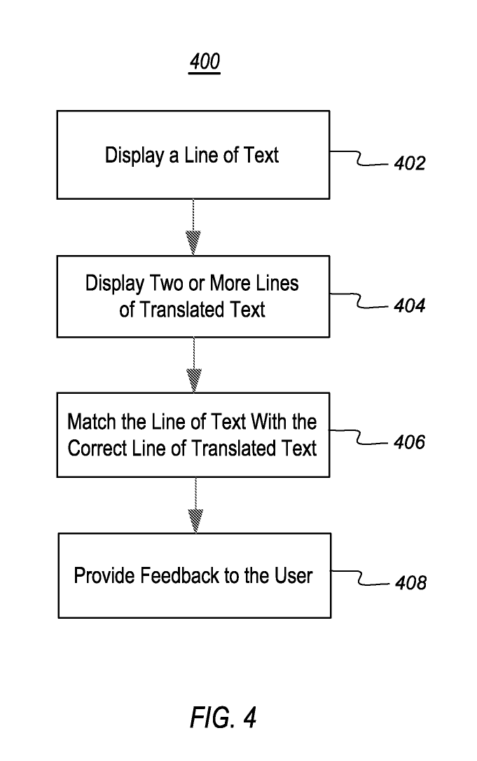

FIG. 4 is a flow chart illustrating a method 400 of teaching a user a target language using a quick match mode. In at least one implementation, the method 400 can test a user's comprehension. For example, the match may be deduced from some or all of the surrounding text. Therefore, if the user correctly comprehends the text, he/she is more likely to correctly select the matching text, even if similar lines of text are presented.

FIG. 4 shows that the method 400 can include displaying 402 a line of text. The line of text can be in either the user's native language or in the target language. In at least one implementation, the displaying 402 a line of text includes any presentation of the text for visual, tactile or auditive reception. For example, the line of text can be displayed 402 as text on a screen. Additionally or alternatively, the line of text can be displayed 402 as spoken words on speakers for the user to hear. The line of text can be displayed 402 from the text repository 106 after being extracted from the desired media in the media repository 104.

FIG. 4 also shows that the method 400 can include displaying 404 two or more lines of alternate language text. In at least one implementation, the alternate language text can be displayed 404 in the user's native language if the line of text from the media is displayed 402 in the target language. Additionally or alternatively, the alternate language text can be displayed 404 in the target language if the line of text from the media is displayed 402 in the user's native language. Additionally or alternatively, incorrect versions of the answers can be generated by substituting text segments with similar but different variants using the techniques outlined in Imposter Mode (described below).

FIG. 4 further shows that the method 400 can include matching 406 the line of text with the correct line of alternate language text. In at least one implementation, the user must select from among the two or more lines of alternate language text displayed 404 to the user. I.e., the user may be asked to select the correct alternate language text from the two or more lines previously displayed 404. The user may only have a short time to do so, adding to the challenge for the user. For example, the user may be asked to do so in real time, as the line of text is displayed 402.

FIG. 4 additionally shows that the method 400 can include providing 408 feedback to the user. In at least one implementation, the feedback can include textual or image supports that help the user understand where he/she made mistakes. Additionally or alternatively, the feedback can include information about the speed and/or accuracy of the user's answer. Additionally or alternatively, the system may playback a segment of the target media corresponding to the selected answer. If players are competing, penalties may be implemented for incorrect answers. For example, if one user selects an incorrect match, their turn may be skipped, their input may be “frozen” for a specified period of time, they can have points deducted from a score or any other appropriate penalty can be implemented.

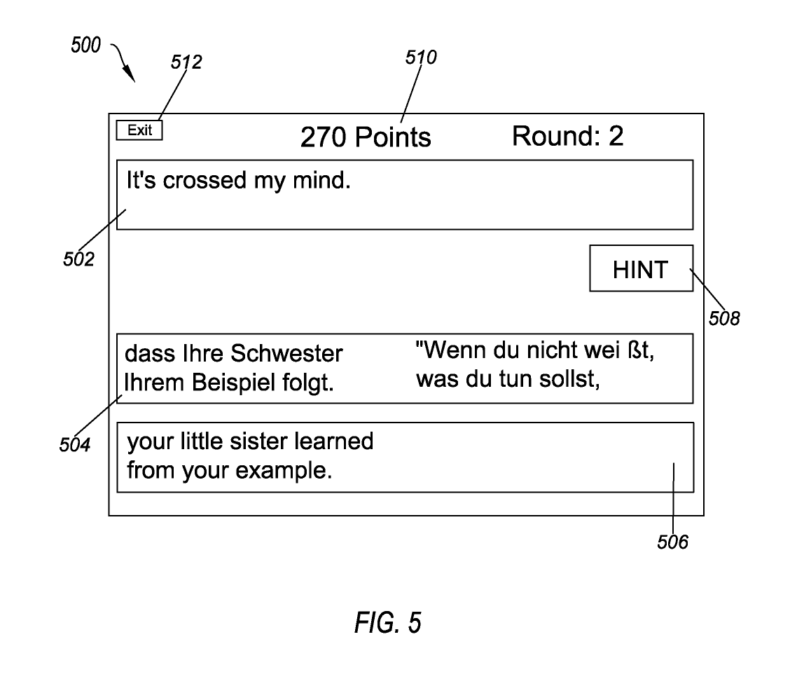

FIG. 5 illustrates an example of a GUI 500 for teaching a user a target language using a quick match mode. In at least one implementation, the GUI 500 can allow the user to interact with the target language. I.e., the user can be immersed in the target language. In particular, the user can be focused on the target language in such a way that the user is interacting with the target language rather than on rote memorization of the target language.

FIG. 5 also shows that the GUI 500 can include a first text box 502. In at least one implementation, the first text box 502 can display to a user a line of text. In particular, the line of text can be in either the user's native language or the target language. The line of text in the first text box 502 can optionally be displayed simultaneously with an image from the media. For example, the image can show the action described in the line of text, the text can be dialogue that is spoken while the image is shown in the media or the image and the line of text can be associated in some other way.

FIG. 5 further shows that the GUI 500 can include a second text box 504. In at least one implementation, the second text box 504 can begin displaying two or more lines of text. In particular, the two or more lines of text in the second text box 504 can be in the either the user's native language or in the target language if the line of text in the first text box 502 is either in the target language or the user's native tongue, respectively. The user can be asked to select the line or text in the second text box 504 which is the correct translation of the text in the first text box 502. Which lines are shown as the two or more lines of text may vary depending on the skill of the user. For example, more advanced users may be given lines of text that are similar to one another and, therefore, more difficult to distinguish by looking at one or two words. In contrast, beginners may be given lines of text that are dissimilar, so that the user can more quickly identify the correct line of text. Additionally or alternatively, incorrect lines may be generated by replacing text segments with similar but different variants using the techniques outlined in the impostor mode, described below.

FIG. 5 additionally shows that the GUI 500 can include a third text box 506. In at least one implementation, the third text box 506 can display text corresponding the user's choice from the second text box 504. I.e., when the user makes a selection in the second text box 504 from among the two or more lines of text, the matching text can be shown in the third text box 506. The matching text can be shown only when the user makes an incorrect choice.

FIG. 5 also shows that the GUI 500 can include one or more hints 508 for the user. In at least one implementation, the one or more hints 508 can allow the user to see a translation of a word, phrase or other text segment in the target language into a word, phrase or other text segment in his/her native language or show an image which can help the user understand the meaning of the word, phrase or other text segment. Additionally or alternatively, the one or more hints 508 can remove one or more incorrect choices, to make it easier for the user to select the correct choice.

FIG. 5 further shows that the GUI 500 can include feedback 510. In at least one implementation, the feedback 510 can allow a user to determine how he/she is doing thus far in the exercise. I.e., the feedback 510 can allow the user to gauge his/her progress thus far. For example, one possible feedback 510 could include a display of the number of correct selections the user has made in a row. Additionally or alternatively, the feedback 510 can be used to determine the difficulty of the exercise for the user. For example, if the user is getting high scores or the exercise otherwise seems too easy for the user, the feedback 510 can be used to automatically adjust the difficulty for the user, the speed at which lines displayed in the second text box 504 are alternated or other game conditions.

FIG. 5 additionally shows that the GUI 500 can include one or more controls 512. In at least one implementation, the one or more controls 512 can allow the user to control the exercise. For example, the user can be asked to select the matching text in the second text box 504 and then select a control 512 for feedback 510. Additionally or alternatively, the user can receive feedback 510 only after the entire exercise is completed. Additionally or alternatively, feedback could include a reward in which some segment of the target media is displayed to the user. Additionally or alternatively, the one or more controls can allow the user to ask for a hint 508, move to the next exercise or perform any other desired function.

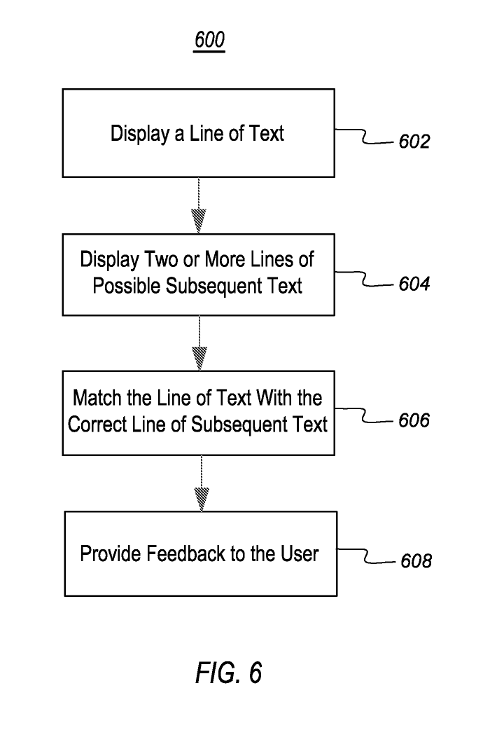

FIG. 6 is a flow chart illustrating a method 600 of teaching a user a target language using a guess the next line mode. In at least one implementation, the method 600 can test a user's comprehension. For example, the next line may be obvious based on the meaning of the currently shown line of text. Therefore, if the user is correctly comprehending the first line, he/she is more likely to correctly select the next line.

FIG. 6 shows that the method 600 can include displaying 602 a line of text. The line of text can be in either the user's native language or in the target language. In at least one implementation, the displaying 602 a line of text includes any presentation of the text for visual, tactile or auditive reception. For example, the line of text can be displayed 602 as text on a screen. Additionally or alternatively, the line of text can be presented 602 as spoken words on speakers for the user to hear. The line of text can be displayed 602 from the text repository 106 after being extracted from the desired media in the media repository 102. Additionally or alternatively, incorrect variants of the correct answer could be generated using the techniques used in the impostor mode, described below.

FIG. 6 also shows that the method 600 can include displaying 604 two or more lines of possible subsequent text. In at least one implementation, the subsequent text can be displayed 604 in the user's native language if the line of text from the media is displayed 602 in the target language. Additionally or alternatively, the subsequent text can be displayed 604 in the target language if the line of text from the media is displayed 602 in either the user's native language or the target language.

FIG. 6 further shows that the method 600 can include matching 606 the line of text with the correct line of subsequent text. In at least one implementation, the user must select the immediately subsequent line in the media from among the two or more lines of alternate language text displayed 604 to the user. I.e., the user may be asked to select the correct subsequent line of text from the two or more lines previously displayed 604. In an alternate implementation, the user must select the immediately prior line in the media from among the two or more alternate language text displayed 604 to the user. In an alternate implementation, players may be asked to identify a line simply as subsequent to the presented line 702, regardless of how far subsequent that line may be. In yet another implementation, players may be asked to identify a line as prior to the presented line 702, regardless of how far prior that line may be. In yet another implementation, players may simply be asked to place the selection lines 704 in the correct order appearing in the media. The user may only have a short time to do so, adding to the challenge for the user.

FIG. 6 additionally shows that the method 600 can include providing 608 feedback to the user. In at least one implementation, the feedback can include textual or image supports that help the user understand where he/she made mistakes. Additionally or alternatively, the feedback can include information about the speed and/or accuracy of the user's answer. Additionally or alternatively, feedback can include a playback of the target media, or display an image extracted from it corresponding to the correct answer.

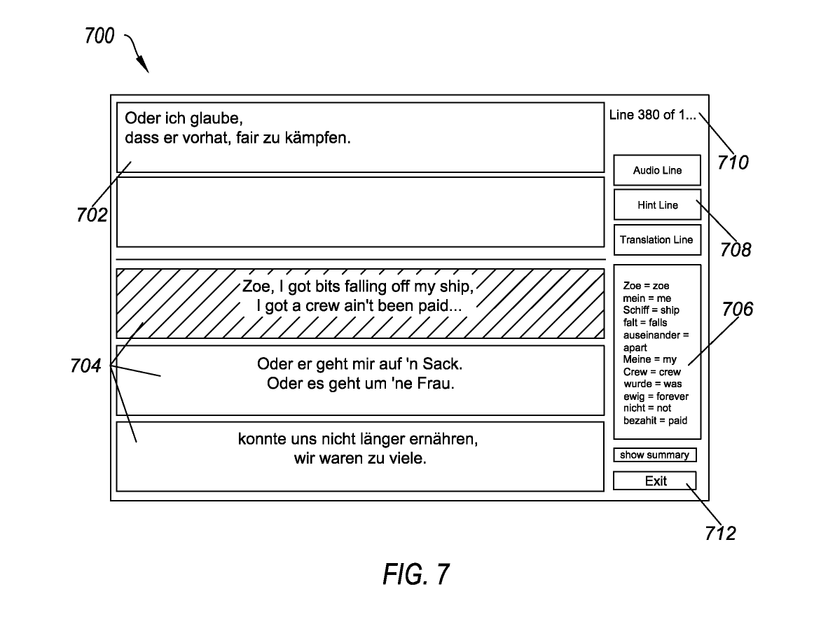

FIG. 7 illustrates an example of a GUI 700 for teaching a user a target language using a guess the next line mode. In at least one implementation, the GUI 700 can allow the user to interact with the target language. I.e., the user can be immersed in the target language. In particular, the user can be focused on the target language in such a way that the user is interacting with the target language rather than on rote memorization of the target language.

FIG. 7 also shows that the GUI 700 can include a first text box 702. In at least one implementation, the first text box 702 can display to a user a line of text. In particular, the line of text can be in the either the user's native tongue or in the target language. The line of text in the first text box 702 can be displayed simultaneously with an image from the media. For example, the image can show the action described in the line of text, the text can be dialogue that is spoken while the image is shown in the media or the image and the line of text can be associated in some other way.

FIG. 7 further shows that the GUI 700 can include a second text box 704. In at least one implementation, the second text box 704 can display two or more lines of text. In particular, the two or more lines of text in the second text box 704 can be in the either the user's native language or in the target language if the line of text in the first text box 702 is either in the target language or the user's native tongue, respectively. The user can be asked to select the line or text in the second text box 704 which is the subsequent line of text in media relative to the line of text in the first text box 702. Which lines are shown as the two or more lines of text may vary depending on the skill of the user. For example, more advanced users may be given lines of text that are similar to one another and, therefore, more difficult to distinguish by looking at one or two words. In contrast, beginners may be given lines of text that are dissimilar, so that the user can more quickly identify the correct line of text.

FIG. 7 additionally shows that the GUI 700 can include a third text box 706. In at least one implementation, the third text box 706 can display text corresponding the user's choice from the second text box 704. I.e., when the user makes an incorrect selection in the second text box 704 from among the two or more lines of text, the matching text can be shown in the second text box 704. Additionally or alternatively, the third text box 706 can show translations of each word or phrase from the line of text selected by the user in the second text box 704.

FIG. 7 also shows that the GUI 700 can include one or more hints 708 for the user. In at least one implementation, the one or more hints 708 can allow the user to see a translation of a word or phrase in the target language into a word or phrase in his/her native language or show an image which can help the user understand the meaning of the word or phrase. Additionally or alternatively, hint 708 can provide a translation of the starting line, so that players then only need to think through the translations of the lines of text in second text box 704. Additionally or alternatively, the hint 708 can include provide text of the line appearing two lines after the text line in the first text box 702, such that the user need only select the line that would logically go between the two presented lines. Additionally or alternatively, the hint 708 can include playing back the audio from that segment of the movie. Additionally or alternatively, after use, the hint options can go into a “recharging” phase for a period of time, such as one or more turns, before they can be used again.

FIG. 7 further shows that the GUI 700 can include feedback 710. In at least one implementation, the feedback 710 can allow a user to determine how he/she is doing thus far in the exercise. I.e., the feedback 710 can allow the user to gauge his/her progress thus far. Additionally or alternatively, the feedback 710 can be used to determine the difficulty of the exercise for the user. For example, if the user is getting high scores or the exercise otherwise seems too easy for the user, the feedback 710 can be used to automatically increase the difficulty for the user.

FIG. 7 additionally shows that the GUI 700 can include one or more controls 712. In at least one implementation, the one or more controls 712 can allow the user to control the exercise. For example, the user can be asked to select the matching text in the second text box 704 and then select a control 712 for feedback 710. Additionally or alternatively, the user can receive feedback 710 only after the entire exercise is completed. Additionally or alternatively, the one or more controls can allow the user to ask for a hint 708, move to the next exercise or perform any other desired function.

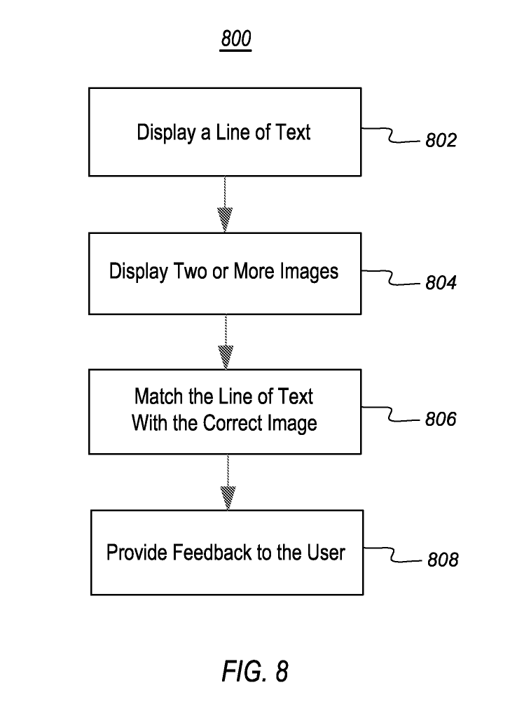

FIG. 8 is a flowchart illustrating a method 800 of teaching a user a target language using a scene match mode. In at least one implementation, the method 800 can test a user's comprehension. For example, the scene may be obvious based on the meaning of the currently shown line of text. Therefore, if the user is correctly comprehending the first line, he/she is more likely to correctly select the correct scene.

FIG. 8 shows that the method 800 can include displaying 802 a line of text. In at least one implementation, the line of text can be displayed 802 in the target language. For example, the line of text can be displayed 802 from the text repository 106 after being extracted from the desired media in the media repository 104. In at least one implementation, the displaying 802 a line of text includes any presentation of the text for visual, tactile or auditive reception. For example, the line of text can be displayed 802 as text on a screen. Additionally or alternatively, the line of text can be presented 802 as spoken words on speakers for the user to hear. The line of text can be displayed 802 from the text repository 106 after being extracted from the desired media in the media repository 104.

FIG. 8 also shows that the method 800 can include displaying 804 two or more images. In at least one implementation, one of the images displayed 804 can be from the corresponding time within the media. For example, the image can be a still image or video clip associated with the dialogue. The other images can be images which occur within the same media or within other media that includes similar or dissimilar dialogue.

FIG. 8 further shows that the method 800 can include matching 806 the line of text with the correct image. In at least one implementation, the user must select the image which corresponds in time within the media with the line of text. I.e., the user may be asked to select the correct image from the two or more images displayed 804. The user may only have a short time to do so, adding to the challenge for the user. For example, the user may be asked to do so in real time, as the line of text is displayed 802 and/or before the dialogue completes.

In at least one implementation, more than one user can attempt to match 806 the line of text with the correct image. I.e., two or more users can each attempt to correctly match 806 the line of text and the image. The two or more users can assist each other or be in competition with one another. For example, the two or more users can work with one another to determine the correct image. Additionally or alternatively, the two or more users can compete with one another. For example, if one user correctly identifies the match, then both users can see the correct image. Alternatively, the users can compete to see who can complete the correct match the quickest or compete in any other desired manner.

FIG. 8 additionally shows that the method 800 can include providing 808 feedback to the user. In at least one implementation, the feedback can include textual or image supports that help the user understand where he/she made mistakes. Additionally or alternatively, the feedback can include information about the speed and/or accuracy of the user's answer. If players are competing, penalties may be implemented for incorrect answers. For example, if one user selects an incorrect image, their turn may be skipped, their input may be “frozen” for a specified period of time, they can have points deducted from a score or any other appropriate penalty can be implemented.

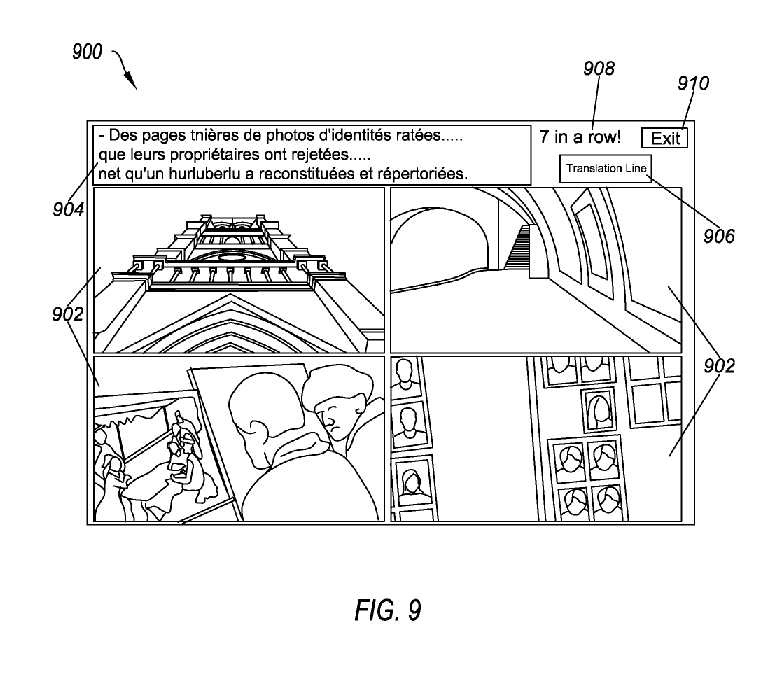

FIG. 9 illustrates an example of a GUI 900 for teaching a user a target language using a scene match mode. In at least one implementation, the GUI 900 can allow the user to interact with the target language. I.e., the user can be immersed in the target language. In particular, the user can be focused on the target language in such a way that the user is interacting with the target language rather than on rote memorization of the target language.

FIG. 9 shows that the GUI 900 can include two or more images 902. In at least one implementation, the two or more images 902 can be a picture or video clip taken from the image repository. I.e., the two or more images 902 can include an image from the media stored in the media repository 102. The user may be able to select from different media in the media repository 102, thus the user may select media with which he/she is already familiar. This can reinforce the language learning because the user is “working” in a familiar environment.

FIG. 9 also shows that the GUI 900 can include a first text box 904. In at least one implementation, the first text box 904 can display to a user a line of text. In particular, the line of text can be in the target language and associated with one of the two or more images 902. I.e., one of the two or more images 902 and the line of text in the first text box 904 can occur simultaneously in the media, one of the two or more images 902 can show the action described in the line of text, or one of the two or more images 902 and the line of text can be associated in some other way.

FIG. 9 also shows that the GUI 900 can include one or more hints 906 for the user. In at least one implementation, the one or more hints 906 can allow the user to see a translation of a word or phrase in the target language into a word or phrase in his/her native language. Additionally or alternatively, the one or more hints 906 can allow the player to see their native language version of the line of text in the first text box 904. Additionally or alternatively, the one or more hints 906 can remove one or more incorrect choices, to make it easier for the user to select the correct choice. Additionally or alternatively, the one or more hits 906 can be used to play an audio recording associated with the text 904. After use, the hint options can go into a “recharging” phase for one or more turns before they can be used again.

FIG. 9 further shows that the GUI 900 can include feedback 908. In at least one implementation, the feedback 908 can allow a user to determine how he/she is doing thus far in the exercise. I.e., the feedback 908 can allow the user to gauge his/her progress thus far. Additionally or alternatively, the feedback 908 can be used to determine the difficulty of the exercise for the user. For example, if the user is getting high scores or the exercise otherwise seems too easy for the user, the feedback 908 can be used to automatically increase the difficulty for the user. Additionally or alternatively, feedback could include a playback of the selected media.

FIG. 9 additionally shows that the GUI 900 can include one or more controls 910. In at least one implementation, the one or more controls 910 can allow the user to control the exercise. Additionally or alternatively, the one or more controls can allow the user to ask for a hint 906, move to the next exercise or perform any other desired function.

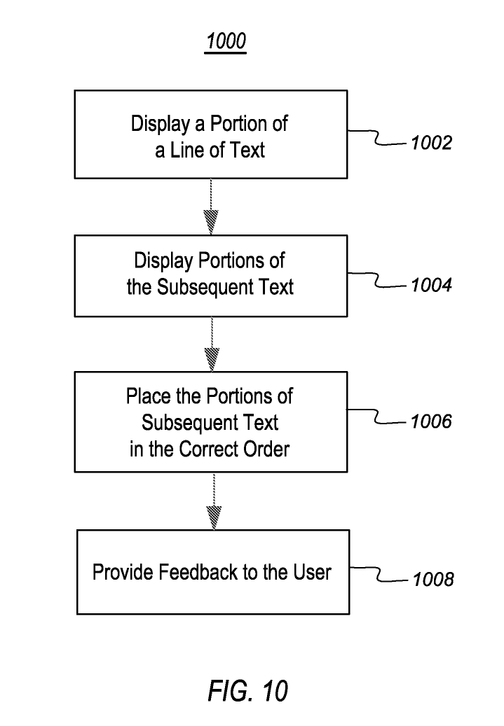

FIG. 10 is a flowchart illustrating a method 1000 of teaching a user a target language using a finger karaoke mode. In at least one implementation, the method 1000 can test a user's comprehension. For example, the next word or phrase may be obvious based on some property of the other currently shown words, phrases or other text segments, like their meaning, syntax, punctuation, length, pronunciation, or some other aspect. Therefore, if the user correctly comprehends the other currently shown words, phrases or other text segments, he/she is more likely to select the correct next word or phrase. Additionally or alternatively, the next word or phrase may be obvious based on listening to the accompanying media. Therefore, if the user is paying attention carefully, he/she is more likely to correctly select the word or phrase.

FIG. 10 shows that the method 1000 can include displaying 1002 a portion of a line of text. In at least one implementation, the line of text can be displayed 1002 in the target language. For example, the line of text can be displayed 1002 from the text repository 106 after being extracted from the desired media in the media repository 102. E.g., the line of text can include an audio clip or be synchronized with a time segment from the selected media which can be played for the user. In at least one implementation, the text segment can be removed or visually altered when the corresponding section of an audio clip passes or at some later time.

FIG. 10 also shows that the method 1000 can include displaying 1004 portions of subsequent text in the target language in scrambled order. In at least one implementation, the text can be in random order. For example, the subtitles, lyrics, or other text from the media translated for popular consumption can be produced and scrambled. Additionally or alternatively, phrases or other text segments can be reordered.

FIG. 10 further shows that the method 1000 can include placing 1006 the portions of the subsequent text in the correct order. In at least one implementation, placing 1006 the portions of the subsequent text in the correct order can allow the user to practice the proper construction of a sentence in the target language. I.e., the user can practice proper word order in the target language by reordering the text into a construction that would be used by a native speaker.

In at least one implementation, more than one user can place 1006 the portions of subsequent text in the correct order. I.e., two or more users can each place 1006 the portions of subsequent text in the correct order. The two or more users can assist each other. For example, the two or more users can work with one another to determine the correct order. Additionally or alternatively, the two or more users can compete with one another. For example, if one user correctly places a portion of the text, then both users can see the correctly placed text, removing it as an option from both players' selection pools, and compete to correctly place the most portions. Alternatively, the users can compete to see who can complete the correct order the quickest or compete in any other desired manner.

FIG. 10 additionally shows that the method 1000 can include providing 1008 feedback to the user. In at least one implementation, the feedback can include textual or image supports that help the user understand where he/she made mistakes. Additionally or alternatively, the feedback can include information about the speed and/or accuracy of the user's answer. If players are competing, additional penalties may be implemented for incorrect answers. For example, if one user places a portion of the text in an incorrect position, their turn may be skipped, their input may be “frozen” for a specified period of time, they can have points deducted from a score or any other appropriate penalty can be implemented. In at least one implementation, if a user makes an incorrect selection, their input can be “frozen” until the corresponding media playback passes the selected text.

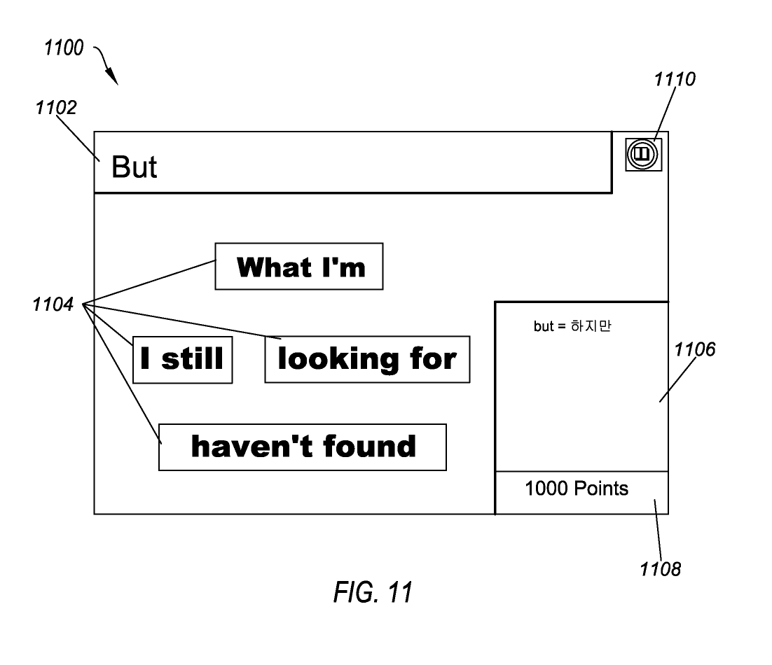

FIG. 11 illustrates an example of a GUI 1100 for teaching a user a target language using a finger karaoke mode. In at least one implementation, the GUI 1100 can allow the user to interact with the target language. I.e., the user can be immersed in the target language. In particular, the user can be focused on the target language in such a way that the user is interacting with the target language rather than on rote memorization of the target language.

FIG. 11 shows that the method 1100 can include displaying 1102 a line of text. The line of text can be in the target language. In at least one implementation, displaying 1102 a line of text includes any presentation of the text for visual, tactile or auditive reception. For example, the line of text can be displayed 1102 as text on a screen. Additionally or alternatively, the line of text can be displayed 1102 as media from its corresponding timestamp is presented on speakers for the user to hear. The line of text can be displayed 1102 from the text repository 106 after being extracted from the desired media in the media repository 102.

FIG. 11 shows that the GUI 1100 can include a first text box 1102. In at least one implementation, the first text box 1102 can begin the round empty. I.e., the first text box 1102 can contain no text when first displayed to the user. Instead, the user can be asked to insert the text in the first text box 1102 which is the target language text or other text segments corresponding to that timestamp in the media. Additionally or alternatively, the first text box 1102 may begin with some of the text inserted as a hint or help to the user.

FIG. 11 also shows that the GUI 1100 can include pieces of text 1104. In at least one implementation, the user can be given some or all of the text that should be assembled in the first text box 1102. For example, if the user is a beginner in the target language, he/she may have some selections made automatically (e.g. already inserted in the first text box 1102) or have fewer pieces of text 1104. Otherwise, a moderately advanced player would be required to reconstruct all segments of text in the first text box 1102, using the pieces of text 1104. When a user makes a correct selection of a lyrics or text segment in 1104 within the correct time window, that text is repositioned to the next open location in 1102 that preserves its ordering with other text segments. When a user makes an incorrect selection, that lyrics or text segment is repositioned to its correct location in 1102, which would not be the next open position, so as to inform the user where and when that text should go. Other text segments are “frozen” until the active time window passes that of the incorrectly selected text segment.

FIG. 11 also shows that the GUI 1100 can include one or more hints 1106 for the user. In at least one implementation, the one or more hints 1106 can allow the user to see a translation of a word or phrase in the target language into a word or phrase in his/her native language or show an image which can help the user understand the meaning of the word or phrase. Additionally or alternatively, the one or more hints 1106 can insert one or more pieces of text 1104 in their correct position within the first text box 1102. Additionally or alternatively, any incorrect text segments included to distract the user from the correct answers 1104 can be removed as a hint. Additionally or alternatively, the one or more hints 1106 can provide grammatical, linguistic, or other pedagogical instruction. Additionally or alternatively, the one or more hints 1106 can include identifying a subset of the visible text to direct the user's attention and make identifying the correct selection easier. After use, the hint options can go into a “recharging” phase for the next few turns before they can be used again.

FIG. 11 further shows that the GUI 1100 can include feedback 1108. In at least one implementation, the feedback 1108 can allow a user to determine how he/she is doing thus far in the exercise. I.e., the feedback 1108 can allow the user to gauge his/her progress thus far. In at least one implementation, a visual representation of accompanying audio can show when users make sufficient correct selections within a time period. Additionally or alternatively, the feedback 1108 can be used to determine the difficulty of the exercise for the user. For example, if the user is getting high scores or the exercise otherwise seems too easy for the user, the feedback 1108 can be used to automatically increase the difficulty for the user. Alternatively, if the user is getting low scores or the exercise otherwise seems too hard for the user, the feedback 1108 can be used to automatically decrease the difficulty for the user.

FIG. 11 additionally shows that the GUI 1100 can include one or more controls 1110. In at least one implementation, the one or more controls 1110 can allow the user to control the exercise. For example, the user can be asked to assemble the pieces of text 1104 in the first text box 1102 and then select a control for feedback 1108. I.e., the user can be asked to complete the complete line of text in the first text box 1102 before showing any feedback 1108. Additionally or alternatively, the one or more controls can allow the user to ask for a hint from among the one or more hints 1106, move to the next exercise or perform any other desired function.

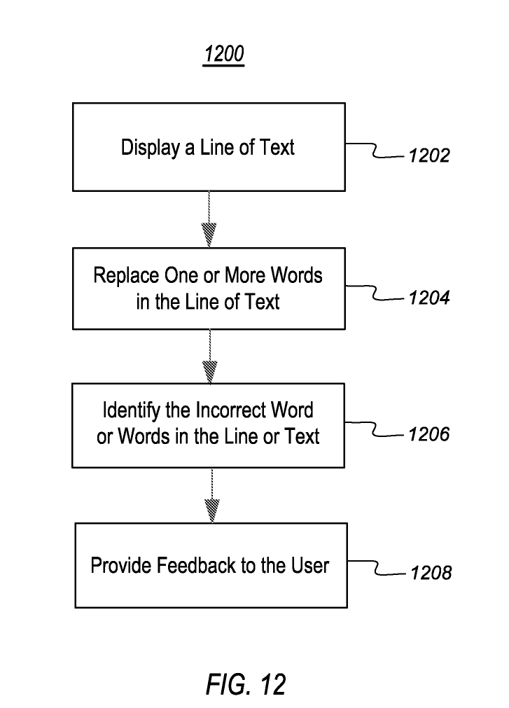

FIG. 12 is a flow chart illustrating a method 1200 of teaching a user a target language using an impostor mode. In at least one implementation, the method 1200 can test a user's comprehension. For example, the impostor may sometimes be deduced from the surrounding text. Therefore, if the user correctly comprehends the surrounding text, he/she is more likely to correctly select the incorrect word. Additionally or alternatively, the next word or phrase may be obvious based on listening to the accompanying media. Therefore, if the user is paying attention carefully, he/she is more likely to correctly select the word or phrase.

FIG. 12 shows that the method 1200 can include displaying 1202 a line of text. The line of text can be in the target language. In at least one implementation, the displaying 1202 a line of text includes any presentation of the text for visual, tactile or auditive reception. For example, the line of text can be displayed 1202 as text on a screen. Additionally or alternatively, the line of text can be displayed 1202 as corresponding media is presented on speakers for the user to hear. The line of text can be displayed 1202 from the text repository 106 after being extracted from the desired media in the media repository 104.

FIG. 12 also shows that the method 1200 can include replacing 1204 one or more words, phrases, syllables, suffixes, or other segments in the line of text. In at least one implementation, the one or more words can be replaced with homophones, or words that are pronounced the same but differ in meaning. In particular, the text can be replaced by the altering system 108. E.g., the word “you” can be replaced with the word “ewe.” Therefore, the user is expected to notice the spelling or appearance differences rather than the differences in sound. In at least one implementation, audio segments can be replaced instead of replacing text, and users see the correct text and listen for sections of the audio that do not match. In at least one implementation, text can be replaced with other text according to any combination of the following parameters:
same- and similar-sounding (you/ewe/you'll, “ice cream”/“I scream”)
different sounding
same- and similar-meaning (e.g. mountain/hill, “a whole lotta”/“a lot of”)
opposite- and different-meaning (e.g. hill/hole, “a lot of”/some)
funny meaning in context, or out of context
multiple meanings (e.g. cup/mug, rob/mug, cup/hold), and
   one of the meanings is related and
      it's a less-common meaning
      it's a more-common meaning
      it's a randomly-common meaning
   more than one meaning is related
   none of the meanings is related
similar looking, real (e.g. weight/height)
similar looking, fake in a way that would
   sound similar (e.g. weight/waight, car/kar) or
   sound different (e.g. weight/woight, car/sar)
different looking real or fake
can function in place of the replaced text in the specific context (e.g. “what” and “that” in “what/that I'm looking for”)
cannot function in place of the replaced text in the specific context
similar degree (e.g. “lots of”/many/much)
different degree (e.g. like/love)
number—plural/singular
   changed to match (e.g. “a friend”/“many friends”)
   changed to not match (e.g. “a friend”/“a friends”)
   changed randomly
other real conjugations/tenses (e.g. ran, running, will run)
   changed to match (e.g. “I am running”/“they are running”)
   changed to not match (e.g. “I am running”/“they am running”)
   changed randomly
fake conjugations/tenses (e.g. conjugating irregular verbs according to regular rules, like “goed” vs “went” or regular verbs according to irregular rules, or irregular verbs according to other irregular rules)
same or similar part of speech (e.g. articles—a/an, conjunctions—or/and, subject/object pronouns—them/they)
different part of speech
re-ordering lyrics segments within a line (e.g. “I can see?”/“Can I see?”)
randomly selected real words and phrases
randomly selected fake words and phrases
   real words with letters or syllables randomly added, subtracted, moved, or substituted
   real phrases with words, syllables, or letters randomly added, subtracted, moved, or substituted
   random or semi-random strings of characters and optionally spaces
   phrases made of randomly or semi-randomly selected real or fake words
repeating more, less, or not at all words, syllables, or characters (e.g. “very” instead of “very, very” or vice versa; “la la la la” instead of “la la la”)
different syllables or characters
   chosen because they're difficult sounds to hear or distinguish for certain learners (e.g. “la la la”/“ra ra ra”), or
   chosen because they're easier sounds to hear or distinguish for certain learners, or
   chosen randomly
missing words, syllables, endings, or characters (e.g. syl-ble/syl-la-ble, or “in beginning”/“in the beginning,” run/runn/running)
different, missing, moved, or extraneous accent marks, vowels, or consonants (e.g. resume/resume, batting/bating, restarant/restaraunt/restaurant)
incompatible phrases—in Finger Karaoke mode, if the full line is “a b c d” and the selectable options are “a b”, “c d”, and “a b c”, the latter is a distractor because there's no phrase that's just “d” to complete the line.
phrases with too many words—the phrases don't work in the context of the song or game, regardless of whether the words work in the context of the phrase
similar segments in appearance, sound, and/or meaning (e.g. “a lot” instead of “a whole lot”)
has an image
similar image in color, shape, and/or category/tag (e.g. grapefruit/orange are similar shape and color and both categorized fruit)
different image in color, shape, and/or category/tag
random image
does not have an image
high frequency usage, less commonly used word, or random
easier/clearer images (e.g. a common object like a fork), or harder/ambiguous images (e.g. an abstract concept like calmness)
length (similar length is harder)
segments from different points in the song or other songs (e.g. correct for the 1st refrain, but the 3rd refrain is slightly different)
not vulgar, or not more vulgar than the song
any combination of two or more of the above categories (e.g. look and sound the same or similar—site/cite, mountain/fountain)

FIG. 12 further shows that the method 1200 can include identifying 1206 the incorrect word or words in the line of text. In at least one implementation, the user may only have a short time to do so, adding to the challenge for the user. For example, the user may be asked to do so in real time, as the line of text is displayed 1202 and/or the media plays. E.g., the user may be asked to identify 1206 the incorrect word while subtitles, lyrics or other text are being scrolled or otherwise presented on a screen.

FIG. 12 additionally shows that the method 1200 can include providing 1208 feedback to the user. In at least one implementation, the feedback can include textual or image supports that help the user understand where he/she made mistakes. Additionally or alternatively, the feedback can include information about the speed and/or accuracy of the user's answer. If players are competing, penalties may be implemented for incorrect answers. For example, if one user select an incorrect match, their turn may be skipped, their input may be “frozen” for a specified period of time, they can have points deducted from a score or any other appropriate penalty can be implemented.

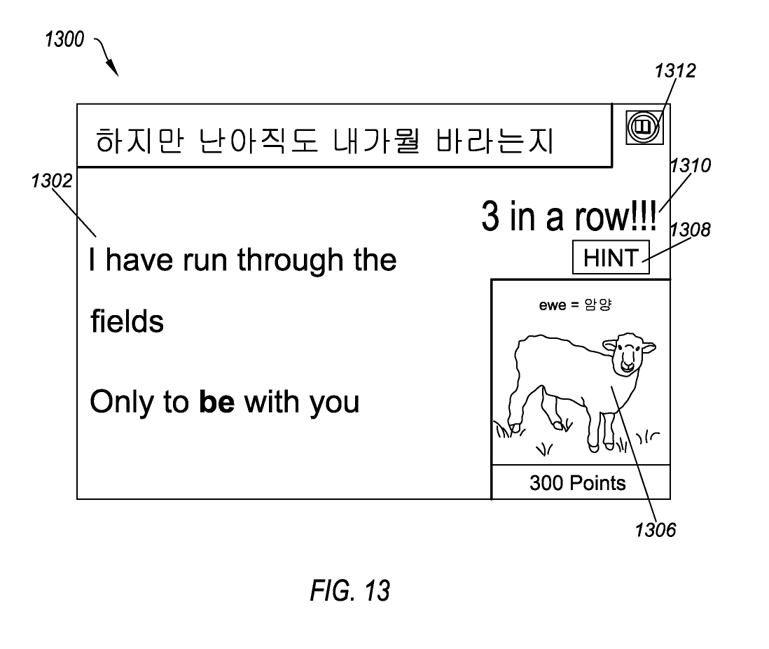

FIG. 13 illustrates an example of a GUI 1300 for teaching a user a target language using an impostor mode. In at least one implementation, the GUI 1300 can allow the user to interact with the target language. I.e., the user can be immersed in the target language. In particular, the user can be focused on the target language in such a way that the user is interacting with the target language rather than on rote memorization of the target language.

FIG. 13 also shows that the GUI 1300 can include a first text box 1302. In at least one implementation, the first text box 1302 can display to a user a line of text. In particular, the line of text in the first text box 1302 can be obtained from text in the text repository 106 and associated with media from the media repository 102. For example, the line of text can include musical lyrics, movie dialogue or other text. The line of text can have one or more words replaced with a homophone or other variant of the correct word, e.g. you/ewe/you'll, mountain/hill, hill/hole, weight/height, weight/waight, weight/woight, “lots of”/many/much, like/love, “a friend”/“many friends”, ran/running/will run, goed/went, a/an, “I can see?”/“Can I see?”, syl-ble/syl-la-ble, résume/résumé,.

FIG. 13 further shows that the line of text can show the correct segment 1304 when the incorrect segment has been correctly identified. In at least one implementation, the correct segment can be highlighted or otherwise identified so that the user can quickly identify the correct segment and see the correct spelling for the segment.

FIG. 13 additionally shows that the GUI 1300 can include an image 1306. In at least one implementation, the image 1306 can be an image of either the correct segment or the incorrect segment. For example, the image 1306 can identify the actual meaning of the homophone which was used to replace the correct segment.

FIG. 13 also shows that the GUI 1300 can include one or more hints 1308 for the user. In at least one implementation, the one or more hints 1308 can allow the user to see a translation of a word or phrase in the target language into a word or phrase in his/her native language or show an image which can help the user understand the meaning of the word or phrase. Additionally or alternatively, the one or more hints 1308 can provide grammatical, linguistic, or other pedagogical instruction. Additionally or alternatively, the one or more hints 1308 can include identifying a subset of the visible text to direct the user's attention and make identifying the incorrect text easier. After use, the hint options can go into a “recharging” phase for the next few turns before they can be used again.

FIG. 13 further shows that the GUI 1300 can include feedback 1310. In at least one implementation, the feedback 1310 can allow a user to determine how he/she is doing thus far in the exercise. I.e., the feedback 1310 can allow the user to gauge his/her progress thus far. Users can also learn from their mistakes using this feedback. For example, in one instance if they do not select an incorrect segment within the correct time window, the missed segment is highlighted 1302 and supporting text/image/other media are presented 1306. Additionally or alternatively, the feedback 1310 can be used to determine the difficulty of the exercise for the user. For example, if the user is getting high scores or the exercise otherwise seems too easy for the user, the feedback 1310 can be used to automatically increase the difficulty for the user. Alternatively, if the user is getting low scores or the exercise otherwise seems too hard for the user, the feedback 1310 can be used to automatically decrease the difficulty for the user.

FIG. 13 additionally shows that the GUI 1300 can include one or more controls 1312. In at least one implementation, the one or more controls 1312 can allow the user to control the exercise. For example, the user can be asked to select the matching text in the second text box 1304 and then select a control 1312 for feedback 1310. Additionally or alternatively, the user can receive feedback 1310 only after the entire exercise is completed. Additionally or alternatively, the one or more controls can allow the user to ask for a hint from the one or more hints 1308, move to the next exercise or perform any other desired function.

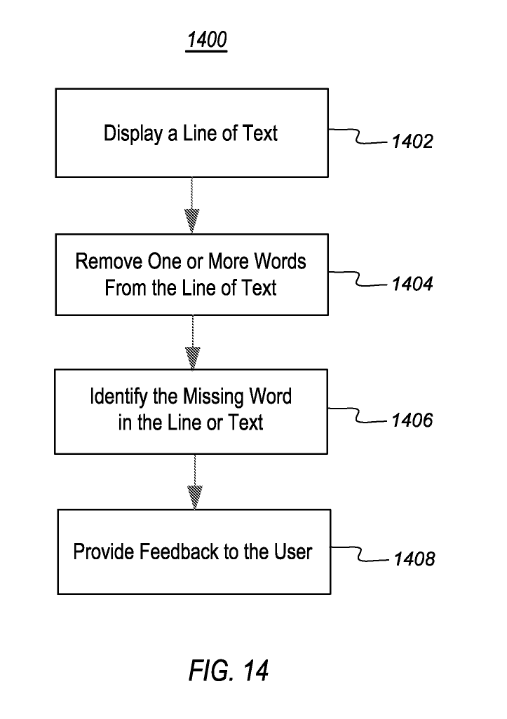

FIG. 14 is a flow chart illustrating a method 1400 of teaching a user a target language using an interlude mode. In at least one implementation, the method 1400 can test a user's comprehension. For example, the missing segment may be deduced from the surrounding text. Therefore, if the user correctly comprehends the surrounding text, he/she is more likely to correctly select the correct segment in the missing space. Additionally or alternatively, the next word or phrase may be obvious based on listening to the accompanying media. Therefore, if the user is paying attention carefully, he/she is more likely to correctly select the word or phrase.

FIG. 14 shows that the method 1400 can include displaying 1402 a line of text. The line of text can be in the target language. In at least one implementation, the displaying 1402 a line of text includes any presentation of the text for visual, tactile or auditive reception. For example, the line of text can be displayed 1402 as text on a screen. Additionally or alternatively, the line of text can be displayed 1402 as media from its corresponding timestamp is presented on speakers for the user to hear. The line of text can be displayed 1402 from the text repository 106 after being extracted from the desired media in the media repository 104.

FIG. 14 also shows that the method 1400 can include altering or removing 1404 one or more segments in the line of text. In particular, the text can be altered or removed by the altering system 108. In at least one implementation, a blank space can identify where the altered or removed segment should be located. Additionally or alternatively, the space where the altered or removed segment belongs can be unidentified, requiring the user to find the space and the correct segment. In at least one implementation, audio segments can be altered instead of altering or removing text, and users see the correct text and listen for sections of the audio that do not match.

FIG. 14 further shows that the method 1400 can include identifying 1406 the missing segment or segments in the line of text. In at least one implementation, the user may only have a short time to do so, adding to the challenge for the user. For example, the user may be asked to do so in real time, as the line of text is displayed 1402 and/or the media plays. E.g., the user may be asked to identify 1406 the missing segment while subtitles, lyrics or other text are being scrolled or otherwise presented on a screen.

FIG. 14 additionally shows that the method 1400 can include providing 1408 feedback to the user. In at least one implementation, the feedback can include textual or image supports that help the user understand where he/she made mistakes. Additionally or alternatively, the feedback can include information about the speed and/or accuracy of the user's answer. If players are competing, additional penalties may be implemented for incorrect answers. For example, if one user select an incorrect match, their turn may be skipped, their input may be “frozen” for a specified period of time, they can have points deducted from a score or any other appropriate penalty can be implemented.

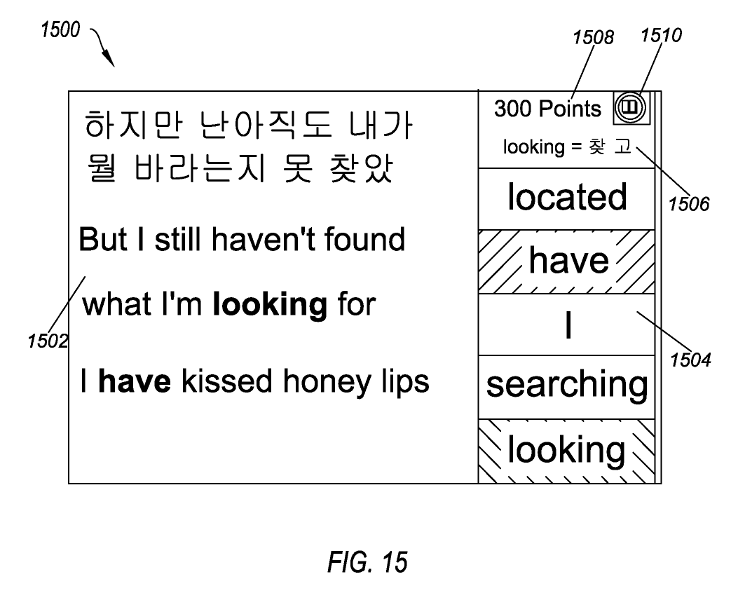

FIG. 15 illustrates an example of a GUI 1500 for teaching a user a target language using an interlude mode. In at least one implementation, the GUI 1500 can allow the user to interact with the target language. I.e., the user can be immersed in the target language. In particular, the user can be focused on the target language in such a way that the user is interacting with the target language rather than on rote memorization of the target language.

FIG. 15 also shows that the GUI 1500 can include a first text box 1502. In at least one implementation, the first text box 1502 can display to a user a line of text. In particular, the line of text in the first text box 1502 can be obtained from text in the text repository 106 and associated with media from the media repository 102. For example, the line of text can include musical lyrics, movie dialogue or other text. The line of text can have one or more segments replaced with a homophone or other variant of the correct segment (e.g. running/runn/run, cooperate/operate, passersby/passerby, “will run”/run, words/word, forty-two/forty, “in the end”/“in the”, “Yes!”/“es!”, forty-two/fortytwo, “I will never”/“I will”, “A lot”/A lot, care/car). In at least one implementation, text segments can be removed to create gaps according to any combination of the following parameters:
suffix (e.g. running/runn/run)
prefix (e.g. cooperate/operate)
infix (e.g. passersby/passerby)
conjugation (e.g. “will run”/run/will)
number (e.g. words/word)
part of a pair (e.g. forty-two/forty)
part of a phrase (e.g. “in the end”/“in the”)
capitals (e.g “Yes!”/“es!”)
punctuation marks (e.g. “Will you?”/“Will you”, forty-two/fortytwo)
funny meaning in context, or out of context (e.g. “I loved the sight your face in the light of the lamp”/“I love lamp”)
opposite or changed meaning (e.g. “I will never do that”/“I will do that”)
ungrammatical and/or nonsensical (e.g. “Will you visit me?”/“Will you me?”)
still grammatical (e.g. removing adjectives or adverbs “The white dove flew”/“The dove flew”)
part of the root/stem (e.g. running/ru)
part of the affix (e.g. running/runni)
spaces (e.g. “A lot of people”/“Alot of people”)
change pronunciation (e.g. removing silent ‘e’: bane/ban, care/car)
creates another real word (e.g. bane/ban)
   that makes sense in context (e.g. “You're my bane, holding me back”/“You're my ban, holding me back”)
   that doesn't make sense in context (e.g. “Please care for me”/“Please car for me”)
creates a fake word (e.g. running/ru)
any word
any syllable
any letter(s)
any phrases

FIG. 15 further shows that the GUI 1500 can include a second text box 1504. In at least one implementation, the second text box 1504 can include two or more segments. One of the two or more segments in the second text box 1504 can be the missing segment from the line of text in the first text box 1502. The user can select the desired segment from among two or more segments. As the user becomes more adept, the segments in the second text box may become more difficult to discern or more numerous or both. For example, if the user is moderately familiar with the target language, he/she may only be given more similar segments, homophones, or be required to type, select, or otherwise insert the correct segments. In contrast, if the user is a beginner in the target language, he/she may be given dissimilar segments in the second text box 1504.

FIG. 15 also shows that the GUI 1500 can include one or more hints 1506 for the user. In at least one implementation, the one or more hints 1506 can allow the user to see a translation of a segment or phrase in the target language into a segment or phrase in his/her native language or show an image which can help the user understand the meaning of the segment or phrase. Additionally or alternatively, the one or more hints 1506 can provide a translation of the starting line, so that players then only need to think through the translations of the lines of text in the second text box 1504. Additionally or alternatively, the one or more hints 1506 can provide grammatical, linguistic, or other pedagogical instruction. Additionally or alternatively, the one or more hints 1506 can include identifying a subset of the visible text to direct the user's attention and make identifying the correct selection easier. After use, the hint options can go into a “recharging” phase for the next few turns before they can be used again.

FIG. 15 further shows that the GUI 1500 can include feedback 1508. In at least one implementation, the feedback 1508 can allow a user to determine how he/she is doing thus far in the exercise. I.e., the feedback 1508 can allow the user to gauge his/her progress thus far. In at least one implementation, the spot where a text segment is missing is not initially visible; words move apart to reveal the gap after a selection is made. If the selection was correct, the correct answer moves into the newly revealed gap. If the selection was incorrect, the gap remains blank, making a second attempt easier than the first because it focuses the user's attention. As further feedback, if a suffix or other text segment is selected that would attach to the text surrounding the missing segment spot, it either attaches if correct or appears to attempt to attach and breaks apart if incorrect. Additionally or alternatively, the feedback 1508 can be used to determine the difficulty of the exercise for the user. For example, if the user is getting high scores or the exercise otherwise seems too easy for the user, the feedback 1508 can be used to automatically adjust the difficulty for the user. Alternatively, if the user is getting low scores or the exercise otherwise seems too hard for the user, the feedback 1508 can be used to automatically adjust the difficulty for the user.

FIG. 15 additionally shows that the GUI 1500 can include one or more controls 1510. In at least one implementation, the one or more controls 1510 can allow the user to control the exercise. For example, the user can be asked to select the matching text in the second text box 1504 and then select a control 1510 for feedback 1508. Additionally or alternatively, the user can receive feedback 1508 only after the entire exercise is completed. Additionally or alternatively, the one or more controls can allow the user to ask for a hint from the one or more hints 1506, move to the next exercise or perform any other desired function.

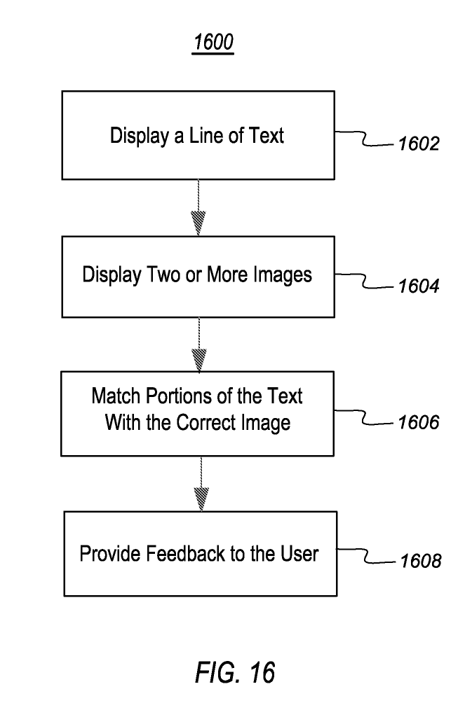

FIG. 16 is a flowchart illustrating a method 1600 of teaching a user a target language using a picture it mode. In at least one implementation, the method 600 can test a user's comprehension. For example, the corresponding image may be obvious based on the meaning of the currently shown line of text. Therefore, if the user correctly comprehends the text line, he/she is more likely to correctly select the corresponding image.

FIG. 16 shows that the method 1600 can include displaying 1602 a line of text. In at least one implementation, the line of text can be displayed 1602 in the target language. For example, the line of text can be displayed 1602 from the text repository 106 after being extracted from the desired media in the media repository 102.

FIG. 16 also shows that the method 1600 can include displaying 1604 two or more images. In at least one implementation, the two or more images can each be related in some manner to a segment or phrase with the line of text. For example, the image can be a heart to be associated with the word “heart”. In at least one implementation, the other images can be images which match other segments within the same media, that match similar or opposite segments, or that do not match.

FIG. 16 further shows that the method 1600 can include matching 1606 portions of the text with the correct image 1606. In at least one implementation, the user must select the image which corresponds in real time as the text is being displayed and/or the corresponding media is being played. In particular, the user may be asked to select the correct image from the two or more images displayed 1604 in real time. The user may only have a short time to do so, adding to the challenge for the user.

In at least one implementation, more than one user can attempt to match 1606 the line of text with the correct image. I.e., two or more users can each attempt to correctly match 1606 the line of text and/or corresponding media with the associated image. The two or more users can work with one another to determine the correct image. Additionally or alternatively, the two or more users can compete with one another. For example, if one user correctly identifies the match, then both users can see which is the correct image and then that selection option is removed for both players. In this way, the users can compete to see who can complete the correct match the quickest or compete in any other desired manner.

FIG. 16 additionally shows that the method 1600 can include providing 1608 feedback to the user. In at least one implementation, the feedback can include textual or image supports that help the user understand where he/she made correct or incorrect selections. For example, on selection, users could see the text associated with an image in the target language, native language, or both. If the selection was correct, it could show which line the selected picture matched. Additionally or alternatively, the feedback can include information about the speed and/or accuracy of the user's answer. If players are competing, penalties may be implemented for incorrect answers. For example, if one user selects an image that does not correspond to either displayed line, their turn may be skipped, their input may be “frozen” for a specified period of time, they can have points deducted from a score or any other appropriate penalty can be implemented.

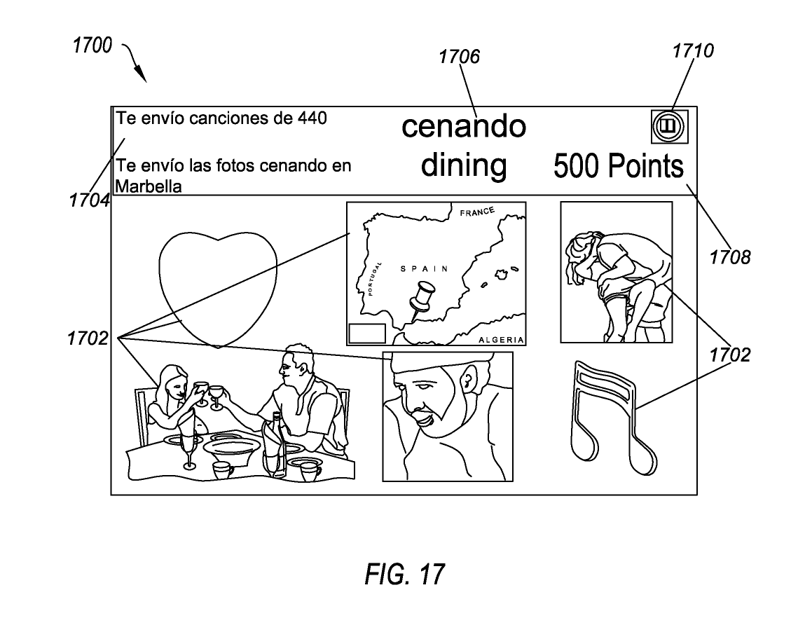

FIG. 17 illustrates an example of a GUI 1700 for teaching a user a target language using a picture it mode. In at least one implementation, the GUI 1700 can allow the user to interact with the target language. I.e., the user can be immersed in the target language. In particular, the user can be focused on the target language in such a way that the user is interacting with the target language rather than on rote memorization of the target language.

FIG. 17 shows that the GUI 1700 can include two or more images 1702. In at least one implementation, the two or more images 1702 can be a picture or video clip taken from the image repository 104 or the media repository 102. The user may be able to select from different media in the media repository 102, thus the user may select media with which he/she is already familiar. This can reinforce the language learning because the user is “working” in a familiar environment.

FIG. 17 also shows that the GUI 1700 can include a first text box 1704. In at least one implementation, the first text box 1704 can display to a user a line of text. In particular, the line of text can be in the target language and associated with one of the two or more images 1702. I.e., one of the two or more images 1702 and the line of text in the first text box 1704 can occur simultaneously in the media or within several seconds of each other, one of the two or more images 1702 can correspond to a segment in the line of text, or one of the two or more images 1702 and the line of text can be associated in some other way.

FIG. 17 also shows that the GUI 1700 can include one or more hints 1706 for the user. In at least one implementation, the one or more hints 1706 can allow the user to see a text label on top of the selected image, which can help the user recognize how the picture does or does not relate to the line of text. Additionally, a text translation may be shown of the text segment associated with the image, which can help the user understand the meaning of the segment or phrase. If the selected image correctly matches a line, that line may be highlighted. Additionally or alternatively, the one or more hints 1706 can remove one or more incorrect choices, to make it easier for the user to select the correct choice. Additionally or alternatively, hint one or more hints 1706 can provide a translation of the line of text in the first text box 1704, so that players then only need to think through the translations of the lines of text in second text box 1706. Additionally or alternatively, the one or more hints 1706 can provide grammatical, linguistic, or other pedagogical instruction. After use, the one or more hints 1706 can go into a “recharging” phase for the next few turns before they can be used again.

FIG. 17 further shows that the GUI 1700 can include feedback 1708. In at least one implementation, the feedback 1708 can allow a user to determine how he/she is doing thus far in the exercise. I.e., the feedback 1708 can allow the user to gauge his/her progress thus far. Additionally or alternatively, the feedback 1708 can be used to determine the difficulty of the exercise for the user. For example, if the user is getting high scores or the exercise otherwise seems too easy for the user, the feedback 1708 can be used to automatically increase the difficulty for the user.

FIG. 17 additionally shows that the GUI 1700 can include one or more controls 1710. In at least one implementation, the one or more controls 1710 can allow the user to control the exercise. Additionally or alternatively, the one or more controls can allow the user to ask for a hint 1706, move to the next exercise or perform any other desired function.

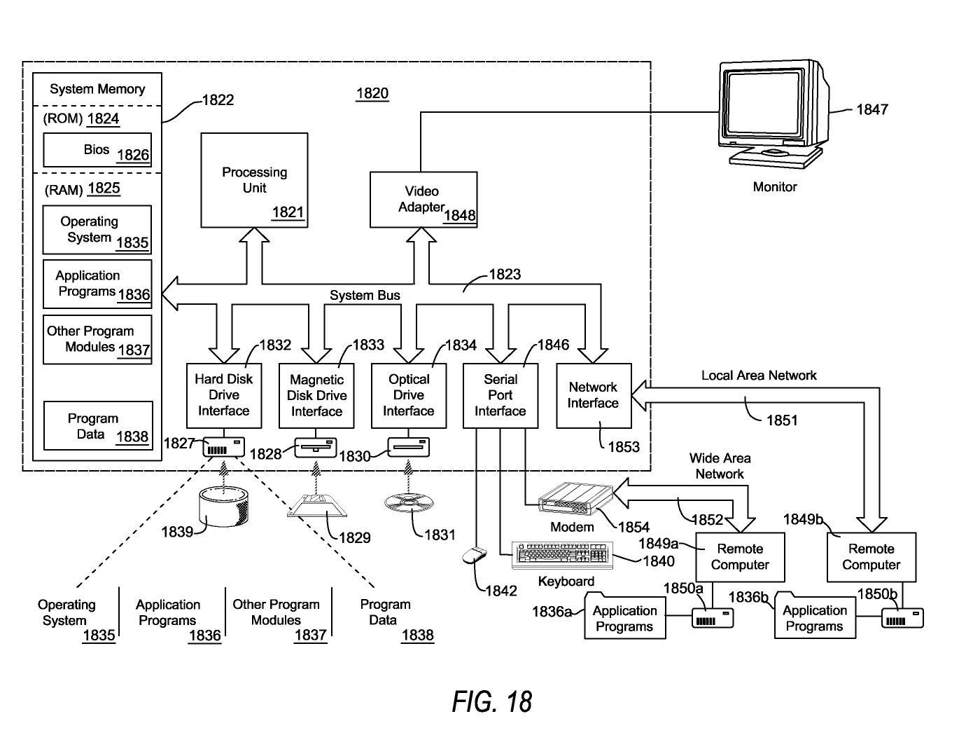

FIG. 18, and the following discussion, is intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One skilled in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 18, an example system for implementing the invention includes a general purpose computing device in the form of a conventional computer 1820, including a processing unit 1821, a system memory 1822, and a system bus 1823 that couples various system components including the system memory 1822 to the processing unit 1821. It should be noted however, that as mobile phones become more sophisticated, mobile phones are beginning to incorporate many of the components illustrated for conventional computer 1820. Accordingly, with relatively minor adjustments, mostly with respect to input/output devices, the description of conventional computer 1820 applies equally to mobile phones. The system bus 1823 may be any of several types of bus structures including a memory bus or memory controller, a peripheral bus, and a local bus using any of a variety of bus architectures. The system memory includes read only memory (ROM) 1824 and random access memory (RAM) 1825. A basic input/output system (BIOS) 1826, containing the basic routines that help transfer information between elements within the computer 1820, such as during start-up, may be stored in ROM 1824.

The computer 1820 may also include a magnetic hard disk drive 1827 for reading from and writing to a magnetic hard disk 1839, a magnetic disk drive 1828 for reading from or writing to a removable magnetic disk 1829, and an optical disc drive 1830 for reading from or writing to removable optical disc 1831 such as a CD-ROM or other optical media. The magnetic hard disk drive 1827, magnetic disk drive 1828, and optical disc drive 1830 are connected to the system bus 1823 by a hard disk drive interface 1832, a magnetic disk drive-interface 1833, and an optical drive interface 1834, respectively. The drives and their associated computer-readable media provide nonvolatile storage of computer-executable instructions, data structures, program modules and other data for the computer 1820. Although the exemplary environment described herein employs a magnetic hard disk 1839, a removable magnetic disk 1829 and a removable optical disc 1831, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 1839, magnetic disk 1829, optical disc 1831, ROM 1824 or RAM 1825, including an operating system 1835, one or more application programs 1836, other program modules 1837, and program data 1838. A user may enter commands and information into the computer 1820 through keyboard 1840, pointing device 1842, or other input devices (not shown), such as a microphone, joy stick, game pad, satellite dish, scanner, or the like. These and other input devices are often connected to the processing unit 1821 through a serial port interface 1846 coupled to system bus 1823. Alternatively, the input devices may be connected by other interfaces, such as a parallel port, a game port or a universal serial bus (USB). A monitor 1847 or another display device is also connected to system bus 1823 via an interface, such as video adapter 1848. In addition to the monitor, personal computers typically include other peripheral output devices (not shown), such as speakers and printers.

The computer 1820 may operate in a networked environment using logical connections to one or more remote computers, such as remote computers 1849a and 1849b. Remote computers 1849a and 1849b may each be another personal computer, a server, a router, a network PC, a peer device or other common network node, and typically include many or all of the elements described above relative to the computer 1820, although only memory storage devices 1850a and 1850b and their associated application programs 1836a and 1836b have been illustrated in FIG. 18. The logical connections depicted in FIG. 18 include a local area network (LAN) 1851 and a wide area network (WAN) 1852 that are presented here by way of example and not limitation. Such networking environments are commonplace in office-wide or enterprise-wide computer networks, intranets and the Internet.

When used in a LAN networking environment, the computer 1820 can be connected to the local network 1851 through a network interface or adapter 1853. When used in a WAN networking environment, the computer 1820 may include a modem 1854, a wireless link, or other means for establishing communications over the wide area network 1852, such as the Internet. The modem 1854, which may be internal or external, is connected to the system bus 1823 via the serial port interface 1846. In a networked environment, program modules depicted relative to the computer 1820, or portions thereof, may be stored in the remote memory storage device. It will be appreciated that the network connections shown are exemplary and other means of establishing communications over wide area network 1852 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for teaching a user a target language, the system comprising:
a media repository, wherein the media repository is configured to store media in the target language;
a text repository, wherein the text repository is configured to store one or more lines of text from the media stored in the media repository; and
a user interface, wherein the user interface is configured to display a line of text stored in the text repository.

2. The system of claim 1 further comprising:
an image repository, wherein the image repository is configured to store one or more images associated with the data stored in the other repositories;
wherein the user interface is configured to display an image stored in the image repository.

3. The system of claim 1 further comprising:
an altering system, wherein the altering system is configured to alter data from the text repository by performing at least one of:
removing segments of text;
reordering segments of text; or
replacing segments of text.

4. The system of claim 1, wherein the media includes at least one of:
a movie;
a tv show
a song;
a game;
a web page;
music;
a book;
a newspaper; or
a magazine.

5. A system for teaching a user a target language, the system comprising:
a display;
media in a target language, wherein at least a portion of the media is presented on the display; and
target language challenges, wherein the target language challenges test a user on portions of the media.

6. The system of claim 5, wherein the portion of the media includes at least one of:
a line of text;
an audio clip;
an image; or
a video clip.

7. A method for teaching a user a target language, the method comprising:
preparing media for language instruction;
storing the prepared media; and
executing an instruction mode.

8. The method of claim 7, wherein the mode includes:
providing a line of text in a target language in scrambled order; and
allowing the user to unscramble the text in the target language.

9. The method of claim 8 further comprising playing a segment of a musical sting subsequent to the selection of a correct answer.

10. The method of claim 8 further comprising presenting an audio clip, wherein the audio clip is associated with the line of text.

11. The method of claim 8 further comprising associating a time code with the text, wherein the time code identifies the position within an audio clip.

12. The method of claim 8 further comprising automatically reordering a scrambled segment of the line of text if the user fails to reorder the scrambled segment within a specified time after the playback of the audio clip associated with the scrambled segment.

13. The method of claim 7, wherein the mode includes:
displaying a line of text in a first language; and
displaying two or more lines in a second language.

14. The method of claim 13 further comprising:
allowing the user to match one of the two or more lines in the second language with the line of text in the first language.

15. The method of claim 7, wherein the mode includes:
displaying three or more lines of text in the target language, wherein each line contains a line identification number of its ordered position within the media

16. The method of claim 15 further comprising:
allowing the user to determine which of the lines of text holds a position number that is a target distance from another line of text.

17. The method of claim 7, wherein mode includes:
providing a line of text in the target language;
displaying two or more images; and
allowing the user to match one of the two or more images with the line of text.

18. The method of claim 17 further comprising:
providing a hint to the user.

19. The method of claim 18, wherein the hint includes at least one of:
providing a line of native language text corresponding to the line of text;
providing an audio segment corresponding to the line of text; or
removing at least one of the two or more images.

20. The method of claim 7, wherein mode includes:
displaying a line of text in the target language;
altering at least one segment in the line of text; and
allowing the user to identify the altered segment in the line of text.

21. The method of claim 20 further comprising:
providing a hint to the user, wherein the hint includes at least one of:
providing a translation of the altered segment;
providing a translation of the segment replaced by the altered segment;
providing an image corresponding to the altered segment; or
providing an image corresponding to the segment replaced by the altered segment.

22. The method of claim 7, wherein mode includes:
displaying a line of text in the target language;
displaying two or more images; and
allowing the user to match portions of the line of text with the correct image.
